(19) United States
(12) Patent Application Publication
(10) Pub. No.: US 2011/0135286 A1
(43) Pub. Date: Jun. 9, 2011

(54) APPARATUS AND METHOD FOR EXTRACTING KEY FRAMES AND APPARATUS AND METHOD FOR RECORDING BROADCAST SIGNALS USING THE SAME

(75) Inventors: Young-ho MOON, Suwon-si (KR); Woo-sung SHIM, Suwon-si (KR); Eun-kyoung PARK, Seoul (KR); Han-tak KWAK, Suwon-si (KR)

(73) Assignee: SAMSUNG ELECTRONICS CO., LTD., Suwon-si (KR)

(21) Appl. No.: 12/820,526

(22) Filed: Jun. 22, 2010

(30) Foreign Application Priority Data
Dec. 4, 2009 (KR) 10-2009-0119921

(51) Int. Cl. H04N 7/26; H04N 5/14; H04N 9/80; H04N 5/917

(52) U.S. Cl. 386/330; 348/571; 348/E05.062; 348/E07.003; 386/E05.003; 386/241

(57) ABSTRACT

An apparatus and method for extracting key frames and an apparatus and method for recording broadcast signals using the same, the key frame extracting apparatus including a stream information analyzing unit and a key frame extracting unit. The stream information analyzing unit extracts frame information from a video stream. The key frame extracting unit extracts a key frame among frames of the video stream by using the frame information.

### CROSS-REFERENCE TO RELATED PATENT APPLICATION

This application claims priority from Korean Patent Application No. 10-2009-0119921, filed on Dec. 4, 2009 in the Korean Intellectual Property Office, the disclosure of which is incorporated herein in its entirety by reference.

### BACKGROUND

1. Field

Apparatuses and methods consistent with the exemplary embodiments relate to an apparatus and method for extracting a key frame, representing each frame, from a video stream, and more particularly, to an apparatus and method for recording broadcast signals by extracting key frames together with the recording of a broadcast stream.

2. Description of the Related Art

In order to reproduce, after storing a broadcast stream, a specific point or a specific scene of the stored broadcast stream or to search for a desired scene in a broadcast recording apparatus such as a personal video recorder (PVR), it is convenient to use information of a thumbnail or a key frame representing each scene.

In a related art method, a related art PVR stores a transport stream (TS) on a hard disk, transcodes the stored TS into a Motion Picture Experts Group-2 Elementary Stream (MPEG-2 ES) by using a TS parser, decodes the MPEG-2 ES to generate raw data, and analyzes the raw data to detect a scene change point, thereby extracting a key frame. Also, the related art PVR uses a histogram change in the RGB value of the raw data to determine the scene change point.

However, the related art method requires a large storage space to record broadcast signals, has to again decode a broadcast signal viewed primarily by the user, and requires an additional process, such as one performed in Advanced RISC Machine (ARM), to perform a signal processing operation for analyzing the raw data.

### SUMMARY

The exemplary embodiments provide an apparatus and method for extracting key frames without decoding a Motion Picture Experts Group-2 (MPEG-2) stream, and an apparatus and method for recording broadcast signals, which efficiently extracts key frames while saving storage space for the broadcast signals.

According to an aspect of an exemplary embodiment, there is provided an apparatus for extracting a key frame, the apparatus including: a stream information analyzing unit which extracts frame information from a video stream; and a key frame extracting unit which determines a key frame among a plurality of frames of the video stream by using the frame information.

The key frame extracting unit may determine the key frame by using at least one of information about a bit amount of each frame, a type of macroblocks of each frame, a coded block pattern (CBP) of the macroblocks, and a motion vector.

The key frame extracting unit may include bit amounts of I frames and may determine an I frame, which has a bit amount change rate of more than a first threshold value in comparison with a previous I frame and has a bit amount change rate of less than a second threshold value in comparison with a next I frame, among the plurality of frames, as the key frame.

If a number of intra macroblocks included in a frame is more than a third threshold value, the key frame extracting unit may determine the frame as the key frame.

If a number of skip macroblocks included in a frame is more than a fourth threshold value, the key frame extracting unit may determine the frame as the key frame.

The key frame extracting unit may calculate the number of the skip macroblocks by using the CBP information of the macroblocks included in the frame.

The video stream may be a Motion Picture Experts Group-2 (MPEG-2) stream or an H.264 stream.

According to an aspect of another exemplary embodiment, there is provided an apparatus for recording broadcast signals, the apparatus including: a Motion Picture Experts Group-2 (MPEG-2) information analyzing unit which analyzes an MPEG-2 stream to output MPEG-2 broadcast information; a transcoder which transcodes the MPEG-2 stream into an H.264 stream by using the MPEG-2 broadcast information outputted from the MPEG-2 information analyzing unit; a storage unit which stores the H.264 stream; and a key frame extracting unit which determines a key frame by using at least one of the frame information of the MPEG-2 stream included in the MPEG-2 broadcast information and frame information of the H.264 stream generated by the transcoder.

The storage unit may store an image and a frame number corresponding to at least one frame determined as the key frame by the key frame extracting unit.

The storage unit may store additional information between stored key frame information pieces.

According to an aspect of another exemplary embodiment, there is provided a method for extracting a key frame, the method including: extracting frame information from a video stream; and determining a key frame among a plurality of frames of the video stream by using the frame information.

According to an aspect of another exemplary embodiment, there is provided a method for recording broadcast signals, the method including: analyzing a Motion Picture Experts Group-2 (MPEG-2) stream to acquire MPEG-2 broadcast information; transcoding the MPEG-2 stream into an H.264 stream by using the MPEG-2 broadcast information acquired by analyzing the MPEG-2 stream; storing the H.264 stream resulting from the transcoding; and determining a key frame by using at least one of the frame information of the MPEG-2 stream included in the MPEG-2 broadcast information and frame information of the H.264 stream resulting from the transcoding.

According to an aspect of another exemplary embodiment, there is provided a method for recording video signals, the method including: acquiring first frame information from a video stream; transcoding the video stream by using the acquired first frame information; storing the transcoded video stream; and determining a key frame by using at least one of the first frame information and second frame information of the transcoded video stream.

### BRIEF DESCRIPTION OF THE DRAWINGS

The above and other features and advantages will become more apparent by describing in detail exemplary embodiments thereof with reference to the attached drawings in which:

FIG. 1 illustrates a block diagram of a key frame extracting apparatus according to an exemplary embodiment;

FIG. 2 illustrates a block diagram of a broadcasting apparatus according to another exemplary embodiment;

FIG. 3 illustrates a graph of a process for determining a key frame by the bit amount of an intra-coded picture (I) frame, according to another exemplary embodiment;

FIGS. 4 and 5 illustrate examples of a key frame determined by the bit amount of an I frame, according to exemplary embodiments;

FIG. 6 illustrates a graph of a process for determining a key frame by the type of a macroblock, according to another exemplary embodiment;

FIGS. 7 and 8 illustrate examples of a key frame determined by the type of a macroblock, according to exemplary embodiments; and

FIG. 9 illustrates additional information stored together with key frame information, according to another exemplary embodiment.

### DETAILED DESCRIPTION OF THE EXEMPLARY EMBODIMENTS

The exemplary embodiments will now be described more fully with reference to the accompanying drawings, in which exemplary embodiments are shown. Exemplary embodiments may, however, be embodied in many different forms and should not be construed as being limited to the exemplary embodiments set forth herein; rather, these exemplary embodiments are provided so that this disclosure will be thorough and complete, and will fully convey the concept of the exemplary embodiments to those of ordinary skill in the art. Expressions such as “at least one of,” when preceding a list of elements, modify the entire list of elements and do not modify the individual elements of the list.

Hereinafter, exemplary embodiments will be described in detail with reference to the accompanying drawings.

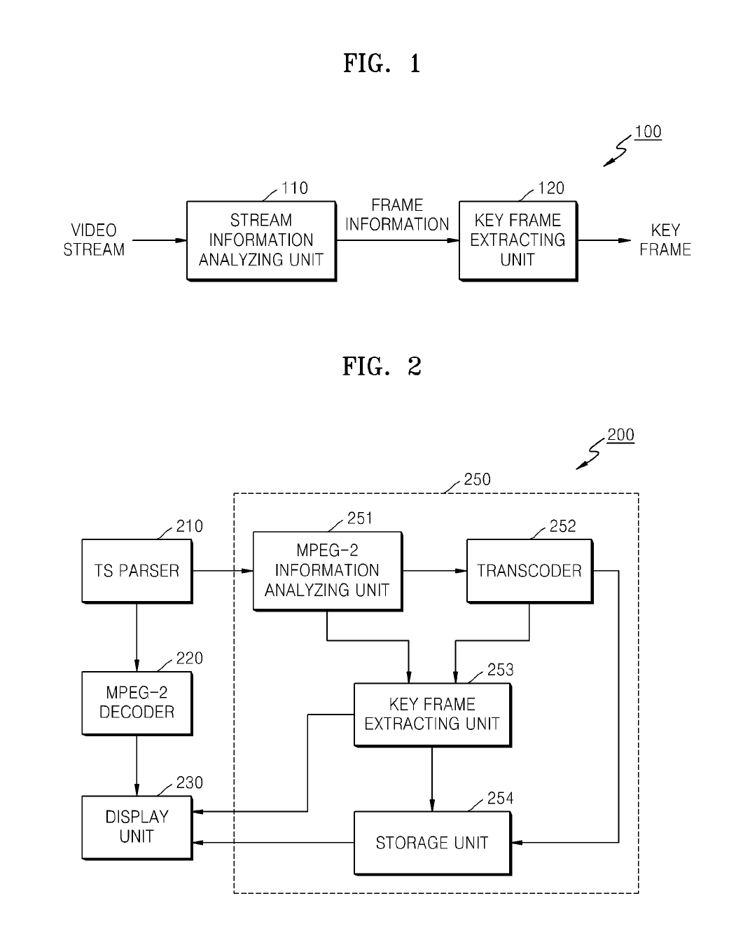

FIG. 1 illustrates a block diagram of a key frame extracting apparatus 100 according to an exemplary embodiment. Referring to FIG. 1, the key frame extracting apparatus 100 includes: a stream information analyzing unit 110 which extracts frame information from an input video stream; and a key frame extracting unit 120 which extracts a key frame by using the extracted frame information. The input video stream may be an MPEG-2 stream or an H.264 stream. According to an exemplary embodiment, the key frame may be extracted using header information without the need to decode the input video stream.

For example, the frame information used in determining the key frame includes at least one of information about the amount of bits used by each frame (FrameUsedBit), the type of macroblocks of each frame (MB_Type), the coded block pattern (CBP) of the macroblocks, and a motion vector, and may be used to determine the occurrence/nonoccurrence of a scene change. For example, the frame of the scene change point may be determined as the key frame.

FIG. 2 illustrates a block diagram of a broadcasting apparatus 200 according to another exemplary embodiment. The broadcasting apparatus 200 includes a broadcast recording apparatus 250 using the key frame extracting method described above.

Referring to FIG. 2, the broadcast recording apparatus 250 includes: an MPEG-2 information analyzing unit 251 which analyzes an input MPEG-2 stream to output MPEG-2 broadcast information; a transcoder 252 which uses the MPEG-2 broadcast information to transcode the input MPEG-2 stream into an H.264 stream with a higher compression ratio; a storage unit 254 which stores the H.264 stream; and a key frame extracting unit 253 which extracts at least one key frame by using frame information included in the stream. The key frame extracting unit 253 may extract the key frame by using at least one of the frame information of the MPEG-2 stream included in the MPEG-2 broadcast information and the frame information of the H.264 stream generated by the transcoder 252. Information about the extracted key frames may be displayed in real time or may be stored in the storage unit 254 for later use. Herein, a frame number and an image and/or a thumbnail corresponding to each key frame may be stored as the key frame information in the storage unit 254.

Referring to FIG. 2, the broadcasting apparatus 200 decodes and plays broadcast signals received from an external device. To this end, the broadcasting apparatus 200 may further include: a TS parser 210 which parses a TS stream; an MPEG-2 decoder 220 which decodes an MPEG-2 ES resulting from the parsing of the TS stream; and a display unit 230 which displays the decoded data and the key frame information.

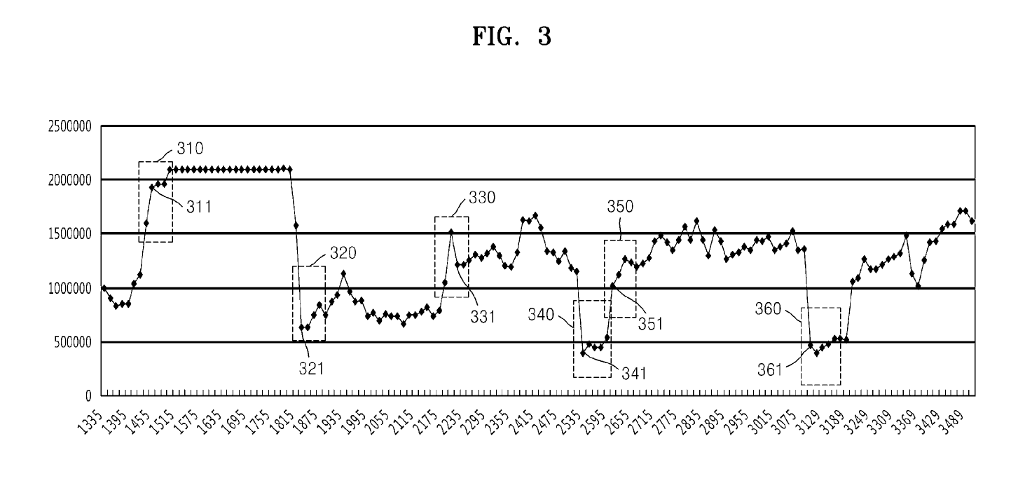

Hereinafter, with reference to FIGS. 3 to 8, a description will be given of exemplary embodiments for extracting key frames by using frame information.

FIG. 3 illustrates a graph of a process for determining a key frame by the bit amount of an intra-coded picture (I) frame, according to another exemplary embodiment. Referring to FIG. 3, bit amount information of I frames in an H.264 stream is illustrated in the graph in which the X-axis represents frame numbers and the Y-axis represents bit amounts. The bit amounts of I frames are compared. If the I frame has a bit amount change rate of more than a first threshold value in comparison with the previous I frame and has a bit amount change rate of less than a second threshold value in comparison with the next I frame, the I frame is determined as a key frame. In the illustrated example, the bit amount change becomes rapid in six sections, namely, first through sixth sections 310, 320, 330, 340, 350 and 360 denoted by dashed rectangles. That is, frames 311, 321, 331, 341, 351, and 361, in which the bit amount change is rapid in comparison with that of the previous frame and becomes slow from the next frame, may be determined as key frames. The same method may also apply to the case of extracting key frames by using the bit amount information of I frames included in the MPEG-2 stream inputted into the transcoder 252. Key frames may also be extracted by using the ratio of the bit amount of the H.264 frames to the bit amount of the MPEG-2 frames.

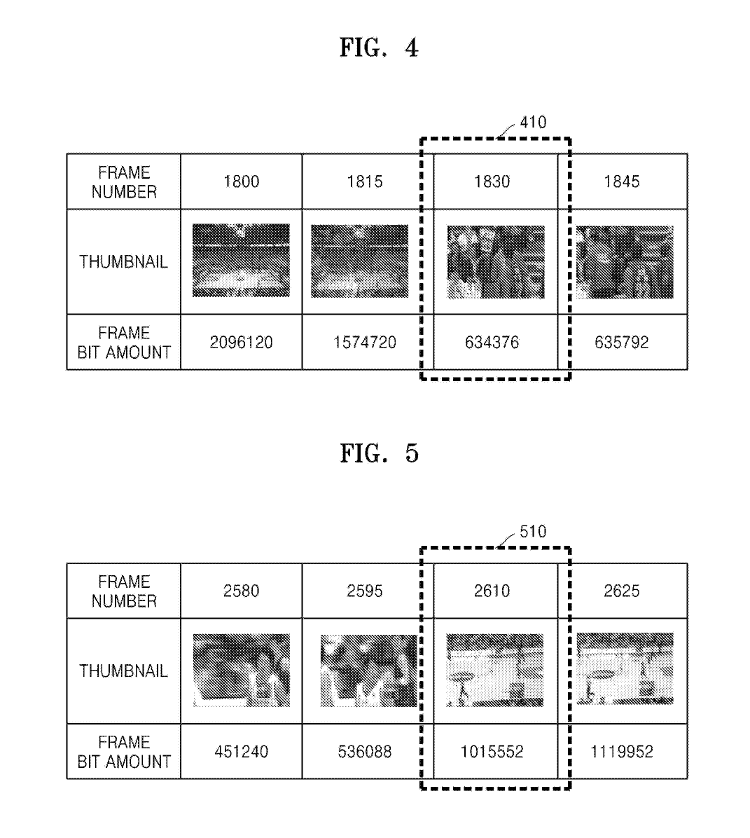

FIGS. 4 and 5 illustrate examples of a key frame determined by the bit amount of the I frame, according to exemplary embodiments. FIG. 4 illustrates 1800^{th}, 1815^{th}, 1830^{th} and 1845^{th} frames that are I frames adjacent to the section 320 of FIG. 3. The 1830^{th} frame 410 of which a bit amount is rapidly reduced in comparison with that of the 1815^{th} frame and is considerably similar to that of the 1845^{th} frame (i.e., the next I frame) is extracted as a key frame. It can be seen that the 1830^{th} frame 410 is the frame of the scene change point.

FIG. 5 illustrates 2580^{th}, 2595^{th}, 2610^{th} and 2625^{th} frames that are I frames adjacent to the fifth section 350 of FIG. 3. The 2610^{th} frame 510 of which a bit amount is rapidly reduced in comparison with that of the 2595^{th} frame and is considerably similar to that of the 2625^{th} frame (i.e., the next I frame) is extracted as a key frame. It can be seen that the 2610^{th} frame 510 is also the frame of the scene change point.

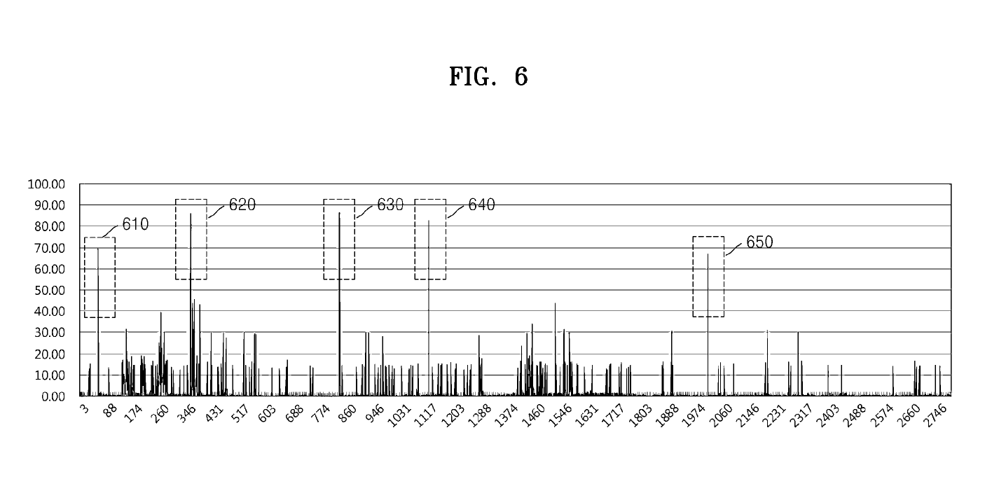

FIG. 6 illustrates a graph of a process for determining a key frame by the type of a macroblock, according to another exemplary embodiment. Referring to FIG. 6, the number of intra macroblocks, among macroblocks of predicted picture (P) frames and bi-predictive picture (B) frames included in an MPEG-2 stream, are illustrated in the graph in which the X-axis represents frame numbers and the Y-axis represents the number of intra macroblocks. If the number of intra macroblocks included in a frame is more than a third threshold value, the frame is determined as a key frame. In the illustrated example, five sections, namely, first through fifth sections 610, 620, 630, 640 and 650 denoted by dashed rectangles, represent frames having intra macroblocks more than a predetermined threshold value. An intra macroblock is a macroblock represented with reference to another macroblock. Furthermore, the probability of a frame being a scene change point increases as the number of intra macroblocks increases. The same method may also apply to the case of extracting key frames by using the macroblock types of P frames and B frames included in an H.264 stream. Key frames may also be extracted by using both the macroblock type distribution of H.264 frames and the macroblock type distribution of MPEG-2 frames.

According to another exemplary embodiment, a method that detects the number of skip macro blocks in a frame and determines the frame as a key frame if the number of skip macroblocks is more than a fourth threshold value may be used. In particular, a frame with many skip macroblocks may be determined as lacking temporal correlation and may be determined as a key frame corresponding to the scene change point. Herein, the number of skip macroblocks may be calculated using coded block pattern (CBP) information, as well as using the type information of macroblocks included in the frame. This may be done by calculating the number of macroblocks with a CBP of 0.

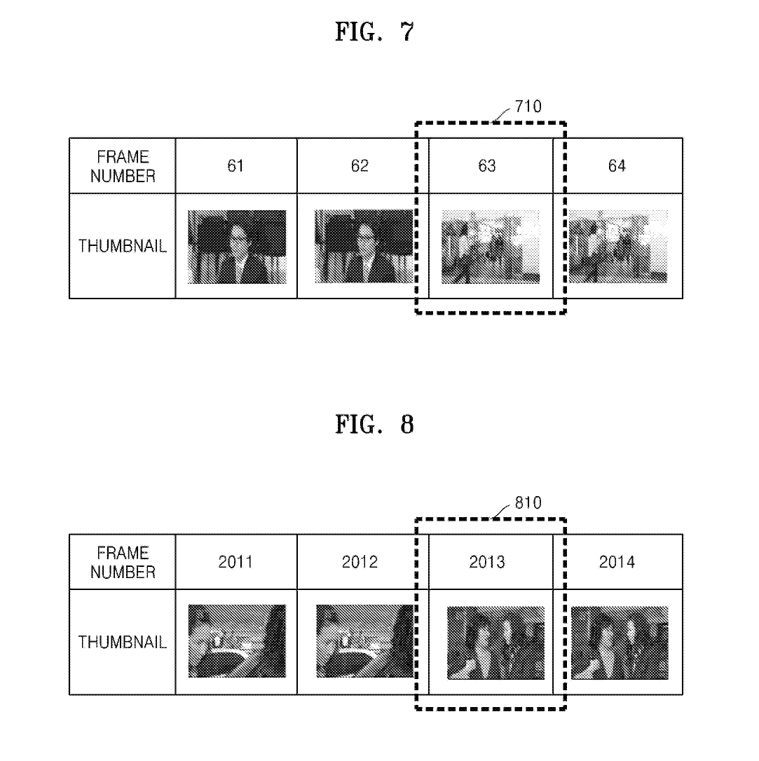

FIGS. 7 and 8 illustrate examples of a key frame determined by the type of a macroblock, according to exemplary embodiments.

FIG. 7 illustrates 61^{st} to 64^{th} frames adjacent to the first section 610 of FIG. 6. The 63^{rd} frame 710, the number of intra macroblocks of which is more than a predetermined value, is extracted as a key frame. It can be seen that the 63^{rd} frame 710 is the frame of the scene change point.

FIG. 8 illustrates 2011^{th} to 2014^{th} frames adjacent to the fifth section 650 of FIG. 6. The 2013^{th} frame 810, the number of intra macroblocks of which is more than a predetermined value, is extracted as a key frame. It can be seen that the 2013^{th} frame 810 is also the frame of the scene change point.

When a key frame representing a scene change is determined using audio features in addition to the above-described video features according to another exemplary embodiment, the key frame may be extracted more accurately. For example, an audio envelope change may be used to determine the point of a rapid sound level change as the scene change point.

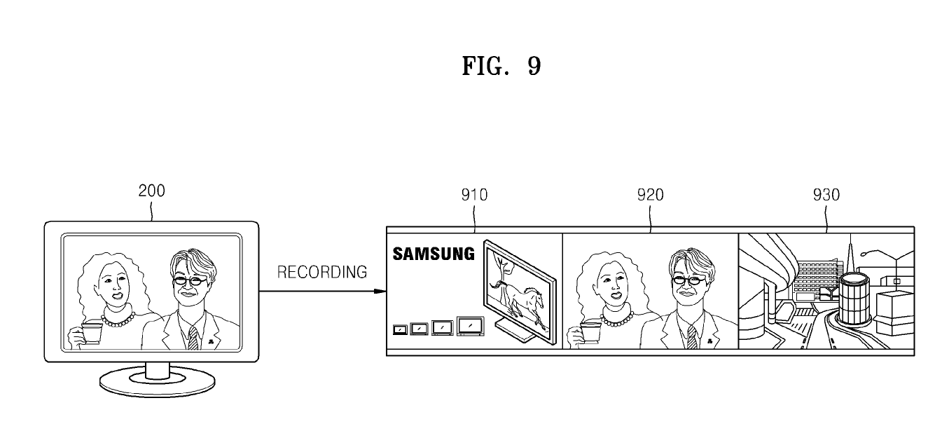

FIG. 9 illustrates additional information stored together with key frame information, according to another exemplary embodiment. Referring to FIG. 9, it can be seen that advertisement images 910 and 930 (i.e., additional information) are inserted and stored before and after key frame information 920 (i.e., between key frames) stored in the storage unit 254, when the broadcasting apparatus 200 records broadcasting signals. The additional information is not limited to advertisement images and may include other information related to the corresponding key frame. Examples of the use of the additional information include: distributing Publication Relations (PR) images periodically; adding user-desired images as additional information; and giving a viewing score to each user in consideration of the frequency of use of a PVR function and the number of times of viewing the recorded broadcast, calculating a grade for each viewing score and allowing free download of video corresponding to additional information stored between key frames according to the calculated grade.

As described above, the exemplary embodiments record broadcast signals and extract key frames while minimizing the use of resources in the system. Thus, it is possible to provide a preview and scene information for enabling a screen movement to a user-desired point.

While not restricted thereto, the exemplary embodiments can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. Also, the exemplary embodiments may be written as computer programs transmitted over a computer-readable transmission medium, such as a carrier wave, and received and implemented in general-use digital computers that execute the programs. Moreover, while not required in all aspects, one or more units of the key frame extracting apparatus 100 or the broadcasting apparatus 200 can include a processor or microprocessor executing a computer program stored in a computer-readable medium, such as the storage unit 254.

While the present inventive concept has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for extracting a key frame, the apparatus comprising:
a stream information analyzing unit which extracts, from a video stream, frame information about a plurality of frames of the video stream; and
a key frame extracting unit which determines the key frame among the plurality of frames by using the extracted frame information.

2. The apparatus of claim 1, wherein the key frame extracting unit determines the key frame by using at least one of information about a bit amount of each of the plurality of frames, a type of macroblocks of each of the plurality of frames, a coded block pattern (CBP) of the macroblocks of each of the plurality of frames, and a motion vector of each of the plurality of frames.

3. The apparatus of claim 1, wherein:
the plurality of frames are intra-coded picture (I) frames; and
the key frame extracting unit compares bit amounts of the I frames and determines an I frame, which has a bit amount change rate of more than a first threshold value in comparison with a previous I frame and has a bit amount change rate of less than a second threshold value in comparison with a next I frame, among the I frames, as the key frame.

4. The apparatus of claim 1, wherein if a number of intra macroblocks included in a frame of the plurality of frames is more than a third threshold value, the key frame extracting unit determines the frame as the key frame.

5. The apparatus of claim 1, wherein if a number of skip macroblocks included in a frame of the plurality of frames is more than a fourth threshold value, the key frame extracting unit determines the frame as the key frame.

6. The apparatus of claim 5, wherein the key frame extracting unit calculates the number of the skip macroblocks by using CBP information of macroblocks included in the frame.

7. The apparatus of claim 1, wherein the video stream is a Motion Picture Experts Group-2 (MPEG-2) stream or an H.264 stream.

8. The apparatus of claim 1, wherein the video stream is an encoded video stream, and the stream information analyzing unit extracts the frame information from the encoded video stream, without decoding the video stream.

9. An apparatus for recording broadcast signals, the apparatus comprising:
a Motion Picture Experts Group-2 (MPEG-2) information analyzing unit which analyzes an MPEG-2 stream to output MPEG-2 broadcast information;
a transcoder which transcodes the MPEG-2 stream into an H.264 stream by using the outputted MPEG-2 broadcast information;
a storage unit which stores the H.264 stream; and
a key frame extracting unit which determines a key frame by using at least one of frame information of the MPEG-2 stream included in the outputted MPEG-2 broadcast information and frame information of the H.264 stream generated by the transcoder.

10. The apparatus of claim 9, wherein the storage unit stores an image and a frame number corresponding to the determined key frame.

11. The apparatus of claim 10, wherein the storage unit stores additional information between stored key frame information pieces.

12. A method for extracting a key frame, the method comprising:
extracting, from a video stream, frame information about a plurality of frames of the video stream; and
determining the key frame among the plurality of frames by using the extracted frame information.

13. The method of claim 12, wherein the determining the key frame comprises extracting the key frame by using at least one of information about a bit amount of each of the plurality of frames, a type of macroblocks of each of the plurality of frames, a coded block pattern (CBP) of the macroblocks of each of the plurality of frames, and a motion vector of each of the plurality of frames.

14. The method of claim 12, wherein:
the plurality of frames are intra-coded (I) frames; and
the determining the key frame comprises comparing bit amounts of the I frames to determine an I frame, which has a bit amount change rate of more than a first threshold value in comparison with a previous I frame and has a bit amount change rate of less than a second threshold value in comparison with a next I frame, among the I frames, as the key frame.

15. The method of claim 12, wherein the determining the key frame comprises determining a frame among the plurality of frames as the key frame if a number of intra macroblocks included in the frame is more than a third threshold value.

16. The method of claim 12, wherein the determining the key frame comprises determining a frame of the plurality of frames as the key frame if a number of skip macroblocks included in the frame is more than a fourth threshold value.

17. A computer-readable recording medium for storing a program for performing a method for extracting a key frame, the method comprising:
extracting, from a video stream, frame information about a plurality of frames of the video stream; and
determining the key frame among the plurality of frames by using the extracted frame information.

18. A method for recording broadcast signals, the method comprising:
analyzing a Motion Picture Experts Group-2 (MPEG-2) stream to acquire MPEG-2 broadcast information;
transcoding the MPEG-2 stream into an H.264 stream by using the acquired MPEG-2 broadcast information;
storing the H.264 stream generated by the transcoding; and
determining a key frame by using at least one of frame information of the MPEG-2 stream included in the acquired MPEG-2 broadcast information and frame information of the H.264 stream generated by the transcoding.

19. The method of claim 18, further comprising storing an image and a frame number corresponding to the determined key frame.

20. The method of claim 19, further comprising storing additional information between stored key frame information pieces.

21. A computer-readable recording medium for storing a program for performing a method for recording broadcast signals, the method comprising:
analyzing a Motion Picture Experts Group-2 (MPEG-2) stream to acquire MPEG-2 broadcast information;
transcoding the MPEG-2 stream into an H.264 stream by using the acquired MPEG-2 broadcast information;
storing the H.264 stream generated by the transcoding; and
determining a key frame by using at least one of frame information of the MPEG-2 stream included in the acquired MPEG-2 broadcast information and frame information of the H.264 stream generated by the transcoding.

22. A method for recording video signals, the method comprising:
acquiring first frame information from a video stream;
transcoding the video stream by using the acquired first frame information;
storing the transcoded video stream; and
determining a key frame by using at least one of the first frame information and second frame information of the transcoded video stream.

23. A computer readable recording medium having recorded thereon a program executable by a computer for performing the method of claim 22.
